(19) United States
(12) Patent Application Publication
(10) Pub. No.: US 2026/0153819 A1
(43) Pub. Date: Jun. 4, 2026

(54) FIXING DEVICE AND IMAGE FORMING APPARATUS

(71) Applicant: FUJIFILM Business Innovation Corp., Tokyo (JP)

(72) Inventors: Taisei SEO, Kanagawa (JP); Motoyuki Yagi, Kanagawa (JP); Yasushi Fujiwara, Kanagawa (JP); Noriaki Kishi, Kanagawa (JP)

(73) Assignee: FUJIFILM Business Innovation Corp., Tokyo (JP)

(21) Appl. No.: 19/188,374

(22) Filed: Apr. 24, 2025

(30) Foreign Application Priority Data
Nov. 29, 2024 (JP) 2024-207956

(51) Int. Cl. G03G 15/20

(52) U.S. Cl. CPC G03G 15/205

(57) ABSTRACT

A fixing device includes a heatable portion that is heated by a heat source, a first temperature detector that detects a temperature of the heatable portion, and a determiner that determines whether the heatable portion has reached a target temperature after correcting detection delay of the first temperature detector using an actual temperature, the actual temperature being obtained by preliminarily detecting a temperature change of the heatable portion at a start of heating using a second temperature detector exhibiting higher responsivity than the first temperature detector.

### CROSS-REFERENCE TO RELATED APPLICATIONS

This application is based on and claims priority under 35 USC 119 from Japanese Patent Application No. 2024-207956 filed November 29, 2024.

### BACKGROUND

### (i) Technical Field

The present disclosure relates to a fixing device and an image forming apparatus.

### (ii) Related Art

Japanese Unexamined Patent Application Publication No. 09-212033 and Japanese Unexamined Patent Application Publication No. 2009-180955 disclose examples of known technologies relating to a fixing device.

Japanese Unexamined Patent Application Publication No. 09-212033 describes a device in which 5 (sec) ≤ Th ≤ 0.23 × DW (sec) and 0.01Th ≤ Ts ≤ 0.08Th, where Th denotes rising time of a heating roller from the room temperature to a fixing temperature, D cm denotes the diameter of the heating roller, W cm denotes the maximum sheet width receivable by the heating roller, and Ts denotes the response time of a temperature sensor.

Japanese Unexamined Patent Application Publication No. 2009-180955 describes a device that includes a first temperature detector that detects the temperature of a heating body by coming into contact with the heating body, and a second temperature detector that is located in a nip area formed by pressing a pressing member and a heat-resistant film contact surface of a supporting body against each other and that is located downstream from the heating body in a movement direction of the heat-resistant film without coming in contact with the heating body.

### SUMMARY

Aspects of non-limiting embodiments of the present disclosure relate to a device capable of determining early whether a heater has reached a target temperature regardless of when the device includes a first temperature detector that has responsivity not relatively high, compared to a case where detection delay of the first temperature detector is not corrected using an actual temperature preliminarily detected by a second temperature detector exhibiting higher responsivity than the first temperature detector used in an actual device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device that includes:

a heatable portion that is heated by a heat source;

a first temperature detector that detects a temperature of the heatable portion; and

a determiner that determines whether the heatable portion has reached a target temperature after correcting detection delay of the first temperature detector using an actual temperature, the actual temperature being obtained by preliminarily detecting a temperature change of the heatable portion at a start of heating using a second temperature detector exhibiting higher responsivity than the first temperature detector.

### BRIEF DESCRIPTION OF THE DRAWINGS

Exemplary embodiments of the present disclosure will be described in detail based on the following figures, wherein:

FIG. 1 is an entire structure diagram of an image forming apparatus including a fixing device according to a first exemplary embodiment of the present disclosure;

FIG. 2 is a block diagram of a control device of an image forming apparatus including the fixing device according to the first exemplary embodiment of the present disclosure;

FIG. 3 is a cross-sectional structure view of the fixing device according to the first exemplary embodiment of the present disclosure;

FIG. 4 is a perspective structure view of the fixing device according to the first exemplary embodiment of the present disclosure;

FIG. 5 is a side view of the fixing device viewed in a direction of an arrow in FIG. 4;

FIG. 6 is a table of the characteristics of a non-contact (NC) sensor and a radiation thermometer;

FIG. 7 is an entire structure diagram of an offline bench for the image forming apparatus including the fixing device according to the first exemplary embodiment of the present disclosure;

FIG. 8 is a graph of detection results obtained by a radiation thermometer detecting the surface temperature of a heating roller;

FIG. 9 is a flowchart of the operation of the image forming apparatus including the fixing device according to the first exemplary embodiment of the present disclosure; and

FIG. 10 is a graph of a change of the surface temperature of a heating roller in accordance with the operation of the image forming apparatus including the fixing device according to the first exemplary embodiment of the present disclosure.

### DETAILED DESCRIPTION

Exemplary embodiments of the present disclosure are described below with reference to the drawings.

### First Exemplary Embodiment

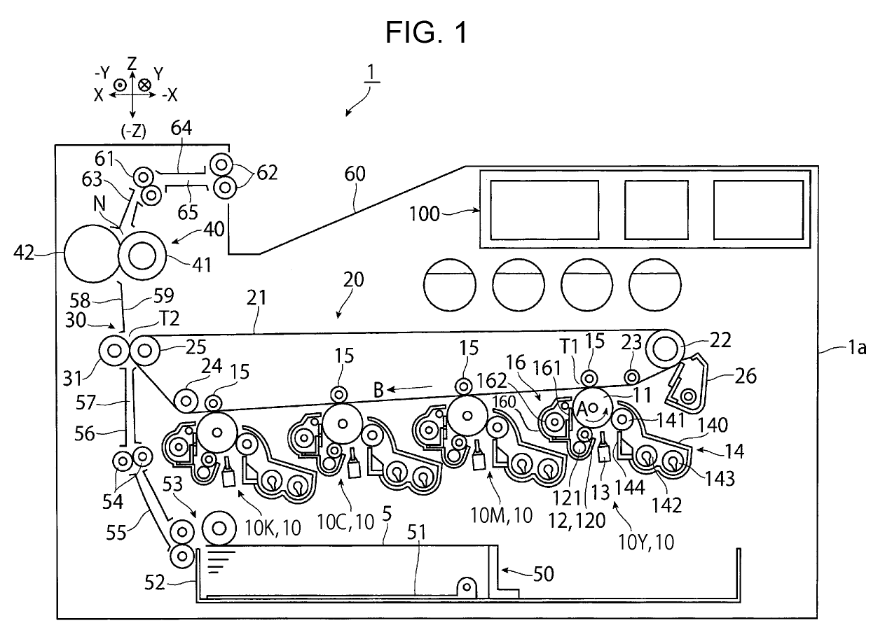

FIG. 1 is a schematic diagram of the entirety of an image forming apparatus including a fixing device according to a first exemplary embodiment. In the drawings, arrow X denotes the width direction parallel to the horizontal direction, arrow Y denotes the depth direction parallel to the horizontal direction, and arrow Z denotes the vertical direction.

### Structure of Entirety of Image Forming Apparatus

An image forming apparatus 1 is, for example, a color printer. As illustrated in FIG. 1, the image forming apparatus 1 includes, for example, multiple image forming devices 10, an intermediate transfer device 20, a sheet feeding device 50, and a fixing device 40. The image forming devices 10 form toner images developed with toner constituting a developer. The intermediate transfer device 20 holds toner images respectively formed by the image forming devices 10, and transports the toner images to a second transfer position T2 at which the toner images are finally second-transferred to a recording sheet 5 serving as an example of a recording medium. The sheet feeding device 50 accommodates and transports an intended recording sheet 5 to be fed to the second transfer position T2 of the intermediate transfer device 20. The fixing device 40 fixes a toner image on the recording sheet 5 second-transferred by the intermediate transfer device 20. Here, the multiple image forming devices 10 and the intermediate transfer device 20 form an image forming unit that forms an image on the recording sheet 5. An apparatus body 1a includes components such as a support structure member and an outer cover.

The image forming devices 10 include four image forming devices 10Y, 10M, 10C, and 10K that are respectively dedicated to form toner images of four colors including yellow (Y), magenta (M), cyan (C), and black (K). These four image forming devices 10 (10Y, 10M, 10C, and 10K) are arranged in an internal space of the apparatus body 1a in a line while being inclined with respect to the horizontal direction X.

As illustrated in FIG. 1, each of the image forming devices 10 (10Y, 10M, 10C, and 10K) includes a photoconductor drum 11 serving as an example of an image carrier that rotates. Around the photoconductor drum 11, components such as a charging device 12, an exposure device 13, a developing device 14, a first transfer device 15, and a drum cleaning device 16 are arranged. The charging device 12 electrically charges, with a predetermined potential, the circumferential surface (the image holding surface) of the photoconductor drum 11 on which an image is formed. The exposure device 13 forms an electrostatic latent image (for the corresponding color) having a potential difference by irradiating the electrically charged circumferential surface of the photoconductor drum 11 with light based on information (a signal) of the image. The developing device 14 develops the electrostatic latent image with toner included in the developer of the corresponding color (Y, M, C, or K) into a toner image. The first transfer device 15 transfers each toner image to the intermediate transfer device 20. The drum cleaning device 16 cleans the photoconductor drum 11 after first transfer by removing extraneous matter such as toner left on and adhering to an image holding surface of the photoconductor drum 11.

The photoconductor drum 11 has the image holding surface having a photoconductive layer (photosensitive layer) formed from a photosensitive material at the circumferential surface of a hollow or solid cylindrical base member that is grounded. The photoconductor drum 11 is supported to rotate in a direction of arrow A with a driving force transmitted from a driving device not illustrated.

The charging device 12 is formed from a contact charging roller 120 disposed to be in contact with the photoconductor drum 11. The charging roller 120 receives a charging voltage. When the developing device 14 performs reversal development, the charging roller 120 receives, as a charging voltage, a voltage or a current of the same polarity as the polarity with which toner fed from the developing device 14 is charged. A cleaning roller 121 that cleans the surface of the charging roller 120 is disposed at the rear surface of the charging roller 120 while being in contact with the rear surface of the charging roller 120.

The exposure device 13 includes, for example, a light emitting diode (LED) print head that forms electrostatic latent images by irradiating the photoconductor drum 11 with light corresponding to image information using light emitting diodes (LEDs) serving as multiple light emitting devices arranged in the axial direction of the photoconductor drum 11. At the time when the exposure device 13 is to form a latent image, image information (signals) input into the image forming apparatus 1 with an appropriate device is transmitted to the exposure device 13.

As illustrated in FIG. 1, each of the developing devices 14 includes a housing 140, a development roller 141, agitation transport members 142 and 143, and a layer thickness restricting member 144. The housing 140 includes an opening portion and a developer accommodating chamber. The development roller 141 holds the developer and transports the developer to a development area facing the photoconductor drum 11. The agitation transport members 142 and 143 each include a component such as a screw auger that transports the developer to allow the developer to pass the development roller 141 while agitating the developer. The layer thickness restricting member 144 restricts the amount (layer thickness) of the developer held by the development roller 141. A development voltage is applied across the development roller 141 and the photoconductor drum 11 from a power supply device not illustrated to the developing device 14. The development roller 141 and the agitation transport members 142 and 143 each rotate in a predetermined direction with a driving force transmitted from a driving device not illustrated. A binary developer containing nonmagnetic toner and a magnetic carrier is used as the developer of each of the four colors (Y, M, C, or K).

The first transfer device 15 is a contact transfer device including a first transfer roller to which a first transfer voltage is fed. The first transfer device 15 rotates while coming into contact with the circumferential surface of the photoconductor drum 11 at a first transfer position T1 with an intermediate transfer belt 21 interposed therebetween. A voltage of a direct current with a polarity opposite to the polarity with which toner is charged is applied as a first transfer voltage from a power supply device not illustrated.

The drum cleaning device 16 includes, for example, a container body 160, a cleaning blade 161, and a dispatching member 162. The cleaning blade 161 is disposed at the opening portion of the container body 160 to clean the photoconductor drum 11 by removing extraneous matter such as remaining toner. The dispatching member 162 includes, for example, a screw auger that recovers extraneous matter such as toner removed by the cleaning blade 161, and transports the extraneous matter to a recovery system not illustrated.

The intermediate transfer device 20 is located above the image forming devices 10 (10Y, 10M, 10C, and 10K) in the vertical direction Z. The intermediate transfer device 20 roughly includes the intermediate transfer belt 21, multiple belt support rollers 22 to 25, a second transfer device 30, and a belt cleaning device 26. The intermediate transfer belt 21 circularly moves in a direction indicated by arrow B while passing the first transfer positions T1 between the photoconductor drum 11 and the first transfer devices 15. The multiple belt support rollers 22 to 25 hold the intermediate transfer belt 21 from the inner periphery in an intended state to allow the intermediate transfer belt 21 to move circularly. The second transfer device 30 is disposed to face the outer peripheral surface (image holding surface) of the intermediate transfer belt 21 supported by the belt support roller 25, to second-transfer a toner image on the intermediate transfer belt 21 to the recording sheet 5. The belt cleaning device 26 removes extraneous matter such as toner or paper dust left on and adhering to the outer peripheral surface of the intermediate transfer belt 21 that has passed the second transfer device 30 to clean the intermediate transfer belt 21.

The intermediate transfer belt 21 is an endless belt formed from a material obtained by dispersing a resistance regulator such as carbon black into a synthetic resin such as a polyimide resin or a polyamide resin. The belt support roller 22 serves as a driving roller. The belt support roller 23 serves as a holding roller that holds the intermediate transfer belt 21 in a travelling position. The belt support roller 24 serves as a sensor roller with which a sensor not illustrated faces. The belt support roller 25 serves as a backup roller for second transfer.

The second transfer device 30 includes a second transfer roller 31 that rotates at a second transfer position T2, which is an outer peripheral surface portion of the intermediate transfer belt 21 supported by the belt support roller 25 of the intermediate transfer device 20. The second transfer roller 31 or the belt support roller 25 of the intermediate transfer device 20 receives a voltage of a direct current with a polarity the same as or opposite to the polarity with which toner is charged as a second transfer voltage.

The fixing device 40 includes components such as a heating roller 41 and a pressing belt 42. The heating roller 41 is heated by a heat source to keep the surface temperature at a predetermined temperature. The pressing belt 42 rotates while being in contact with the heating roller 41 at a predetermined pressure. In the fixing device 40, a contact portion where the heating roller 41 and the pressing belt 42 are in contact serves as a fixing process portion N that performs a predetermined fixing process (heating and pressing). In the first exemplary embodiment, the heating roller 41 is used as an example of a heating rotational body, and the pressing belt 42 is used as an example of a pressing rotational body. However, the examples are not limited to these, and the heating rotational body and the pressing rotational body may have either a roller form or a belt form. The fixing device 40 is described later in detail.

The sheet feeding device 50 is disposed below the image forming devices 10 (10Y, 10M, 10C, and 10K) in the vertical direction Z. The sheet feeding device 50 roughly includes a sheet container 52 and a pick-up device 53. The sheet container 52 accommodates, on a receiving plate 51, a stack of recording sheets 5 of, for example, an intended size or an intended type. The pick-up device 53 picks up the recording sheets 5 one by one from the sheet container 52. The sheet container 52 is attached to be drawn out to, for example, the front of the apparatus body 1a (the side that a user faces when operating the image forming apparatus 1).

Examples of the recording sheets 5 include thin paper sheets including ordinary sheets or tracing paper sheets used for, for example, an electrophotographic copying machine or a printer, and overhead projector (OHP) sheets formed from transparent film media made of a synthetic resin (such as polyethylene terephthalate (PET)). To further improve the smoothness of the image surface that has undergone fixing, the recording sheet 5 preferably has a surface as smooth as possible. For example, a coated paper sheet obtained by coating a surface of an ordinary sheet with resin or another material, or a cardboard sheet with a relatively large basis weight such as an art paper sheet for printing is preferably usable as the recording sheet 5.

A fed-sheet transport path 57 is disposed between the sheet feeding device 50 and the second transfer device 30. The fed-sheet transport path 57 includes one pair (or more pairs) of sheet transport rollers 54 that transport the recording sheets 5 fed from the sheet feeding device 50 to the second transfer position T2, and transport guide members 55 and 56. The pair of sheet transport rollers 54 disposed at a position immediately in front of the second transfer position T2 on the fed-sheet transport path 57 serve as, for example, registration rollers that adjust the timing to transport the recording sheets 5.

A sheet transport path 59 is disposed between the second transfer device 30 and the fixing device 40. The sheet transport path 59 includes, for example, a transport guide member 58 that transports the recording sheets 5 fed from the second transfer device 30 to the fixing device 40.

A discharging transport path 65 is disposed downstream from the fixing device 40. The discharging transport path 65 includes, for example, a pair of sheet transport rollers 61, a pair of sheet discharging rollers 62, and transport guide members 63 and 64 that discharge the recording sheet 5 to which a toner image is fixed by the fixing device 40 to a sheet discharge portion 60 disposed at an upper portion of the apparatus body 1a.

FIG. 1 also illustrates a control device 100 serving as an example of a control unit that generally controls the operations of the image forming apparatus 1.

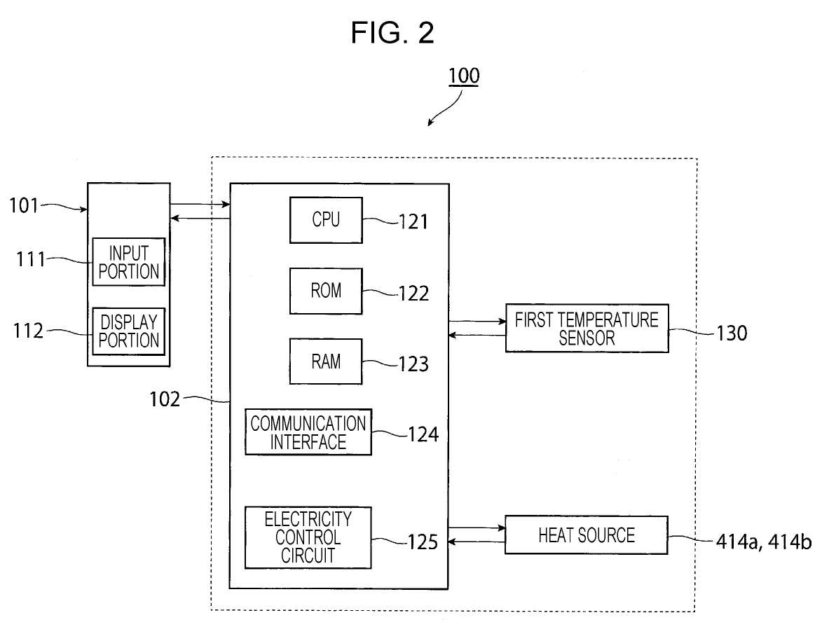

As illustrated in FIG. 2, the control device 100 includes a control panel 101 and a controller 102 that also serves as an example of a determiner of the fixing device 40. The control panel 101 includes an input portion 111 into which a user inputs, for example, intended image forming conditions, and a display portion 112 that displays, for example, the image forming conditions input into the input portion 111 or the state of the image forming apparatus. The controller 102 includes components such as a central processing unit (CPU) 121, a read only memory (ROM) 122, a random access memory (RAM) 123, a bus not illustrated that connects these components including the CPU 121 and the ROM 122, and/or a communication interface 124 that performs communications with external devices. The CPU 121 controls an intended image forming operation including the temperature control or driving of the fixing device 40 based on a program stored in, for example, the ROM 122.

### Basic Operation of Image Forming Apparatus

A basic image forming operation performed by the image forming apparatus 1 is described below.

An image forming operation performed to form a full-color image with a combination of four-color (Y, M, C, and K) toner images using the four image forming devices 10 (10Y, 10M, 10C, and 10K) is described below. An image forming operation performed to form an image with a single color or a combination of multi-color toner images using one or more of the four image forming devices 10 (10Y, 10M, 10C, and 10K) is basically performed in the same manner.

When the image forming apparatus 1 receives request command information for an image forming operation (print) from, for example, the control panel 101, the control device 100 controls components including the image forming devices 10 (10Y, 10M, 10C, and 10K), the intermediate transfer device 20, the second transfer device 30, and the fixing device 40 to actuate the components.

In each of the image forming devices 10 (10Y, 10M, 10C, and 10K), first, the photoconductor drum 11 rotates in a direction of arrow A. The charging device 12 electrically charges the surface of the photoconductor drum 11 with a predetermined polarity (a negative polarity in the first exemplary embodiment) and a predetermined potential. Subsequently, the exposure device 13 exposes the electrically charged surface of the photoconductor drum 11 with light emitted based on an image signal obtained by converting, into a corresponding color component (Y, M, C, or K), image information input into the image forming apparatus 1. Thus, an electrostatic latent image of the color component formed by a predetermined potential difference is formed on the surface of the photoconductor drum 11.

Subsequently, each of the developing devices 14 develops the electrostatic latent image of the color component formed on the photoconductor drum 11 by electrostatically adhering toner of the corresponding color (Y, M, C, or K) electrically charged with the intended polarity (negative polarity) to the electrostatic latent image. With this development, the electrostatic latent image of the color component formed on the photoconductor drum 11 is developed with toner of the corresponding color and formed into a toner image of the corresponding one of four colors (Y, M, C, and K) as a visible image.

Subsequently, the toner image of the corresponding color formed on the photoconductor drum 11 of each of the image forming devices 10 (10Y, 10M, 10C, and 10K) is transported to the first transfer position T1. The first transfer device 15 then first-transfers the toner image of the corresponding color to sequentially overlap the toner image onto the intermediate transfer belt 21 of the intermediate transfer device 20 that rotates in the direction of arrow B.

In each of the image forming devices 10 (10Y, 10M, 10C, and 10K) that has finished first transfer, the drum cleaning device 16 scratches off extraneous matter to clean the surface of the photoconductor drum 11. Thus, each of the image forming devices 10 (10Y, 10M, 10C, and 10K) is prepared for the next image forming operation.

Subsequently, the intermediate transfer device 20 holds the first-transferred toner image and transports the toner image to the second transfer position T2 with rotation of the intermediate transfer belt 21. The sheet feeding device 50 feeds an intended recording sheet 5 to the fed-sheet transport path 57 in accordance with the image forming operation. On the fed-sheet transport path 57, the pair of sheet transport rollers 54 serving as registration rollers feed the recording sheet 5 to the second transfer position T2 in accordance with transfer timing.

At the second transfer position T2, the second transfer roller 31 collectively second-transfers the toner images on the intermediate transfer belt 21 to the recording sheet 5. In the intermediate transfer device 20 that has finished second transfer, the belt cleaning device 26 removes extraneous matter such as toner left on the surface of the intermediate transfer belt 21 after second transfer to clean the intermediate transfer belt 21.

Subsequently, after being released from the intermediate transfer belt 21 and the second transfer roller 31, the recording sheet 5 to which the toner image is second-transferred is transported to the fixing device 40 along the sheet transport path 59. The fixing device 40 introduces the second-transferred recording sheet 5 into the fixing process portion N between the rotating heating roller 41 and the rotating pressing belt 42 to allow the recording sheet 5 to pass through the fixing process portion N. The fixing device 40 thus performs an intended fixing process (heating and pressing) to fix an unfixed toner image to the recording sheet 5. The recording sheet 5 that has undergone the fixing process is discharged by the pair of sheet discharging rollers 62 through the discharging transport path 65 to the sheet discharge portion 60 disposed at an upper portion of the apparatus body 1a.

With the above operation, a full-color image formed with a combination of toner images of toner of the four colors (Y, M, C, and K) is output.

### Structure of Fixing Device

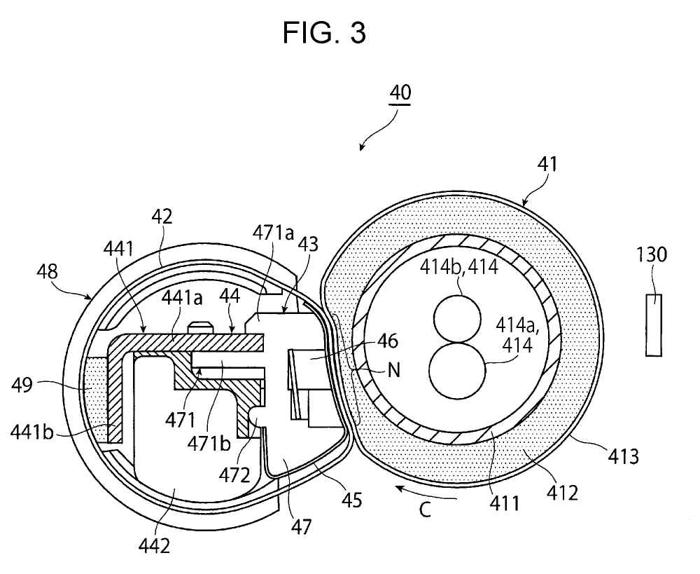

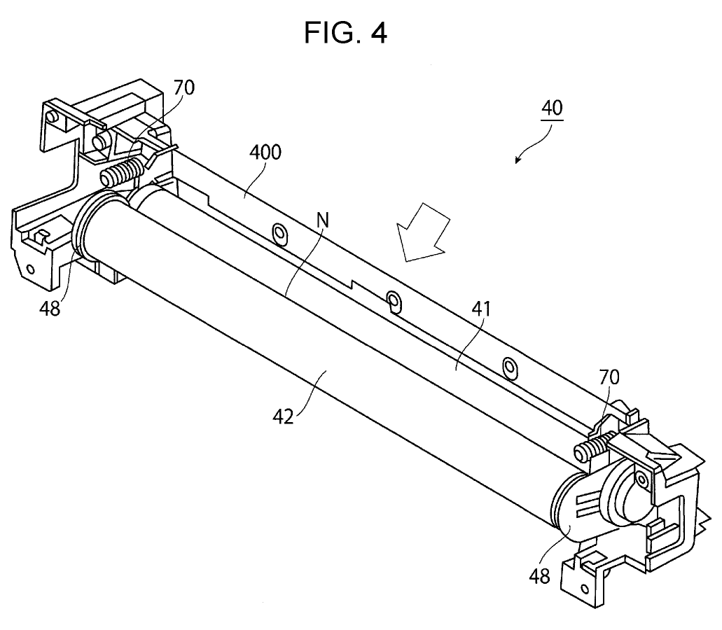

The fixing device 40 is a so-called free belt nip fuser (FBNF) fixing device. As illustrated in FIG. 3 and FIG. 4, the fixing device 40 roughly includes, for example, the heating roller 41 serving as an example of a heatable portion, the pressing belt 42, a pressing member 43, a holding member 44, a sliding sheet 45, and a felt member 49. FIG. 3 and FIG. 4 do not illustrate a housing of the fixing device 40 that covers the outer peripheries of the heating roller 41 and the pressing belt 42. The pressing member 43 is disposed inside the pressing belt 42 and presses the pressing belt 42 against the surface of the heating roller 41. The holding member 44 holds the pressing member 43. The sliding sheet 45 is interposed between the pressing belt 42 and the pressing member 43 to reduce sliding resistance. The felt member 49 holds a lubricant to be applied to the inner peripheral surface of the pressing belt 42.

As illustrated in FIG. 4, for example, the pressing belt 42 is rotatably disposed inside the housing of the fixing device 40 not illustrated. The pressing belt 42 is urged by coil springs 70 serving as examples of an urging members in a direction in which the pressing belt 42 is pressed against the heating roller 41 together with, for example, the holding member 44 to form a fixing process portion N between itself and the heating roller 41.

As illustrated in FIG. 3, the heating roller 41 includes a core 411, an elastic layer 412, and a release layer 413. The core 411 is a hollow cylindrical member formed from a metal such as stainless steel, aluminum, or iron (a thin-walled high strength steel pipe). The elastic layer 412 is formed from a heat-resistant elastic material such as silicone rubber or fluorocarbon rubber coated on the outer circumferential surface of the core 411. The release layer 413 is formed from, for example, polytetrafluoroethylene (PTFE) or perfluoroalkoxy alkanes (PFA) thinly coated on the surface of the elastic layer 412. Halogen lamps 414 are disposed as examples of heat sources inside the heating roller 41. The heating roller 41 is driven to rotate in a direction of arrow C by a driving device not illustrated. In the example illustrated in FIG. 3, the elastic layer 412 has a relatively large thickness. However, the elastic layer 412 preferably has a thickness as small as possible to reduce the heat capacity of the heating roller 41.

The halogen lamps 414 include, for example, a first halogen lamp 414a and a second halogen lamp 414b. The first halogen lamp 414a heats an area with a predetermined width in a center portion in the longitudinal direction of the heating roller 41, for example, an area corresponding to the dimension of the recording sheet 5 of the A4 size in the lateral direction. The second halogen lamp 414b heats both end portions in the longitudinal direction of the heating roller 41. However, the fixing device 40 does not have to include multiple halogen lamps 414, and may simply include a single halogen lamp that heats the entire area of the heating roller 41 in the longitudinal direction.

The surface temperature of the heating roller 41 is detected by a first temperature sensor 130 serving as a first temperature detector. As an example of the first temperature sensor 130, a non-contact (NC) temperature sensor such as a thermistor is used. The first temperature sensor 130 is disposed at a position a predetermined distance away from the surface of the heating roller 41 without being in contact with the heating roller 41. Although the first temperature sensor 130 formed from, for example, a thermistor does not have relatively high responsivity, the first temperature sensor 130 is small and available at a relatively low cost, and is thus suitably installed on an actual device.

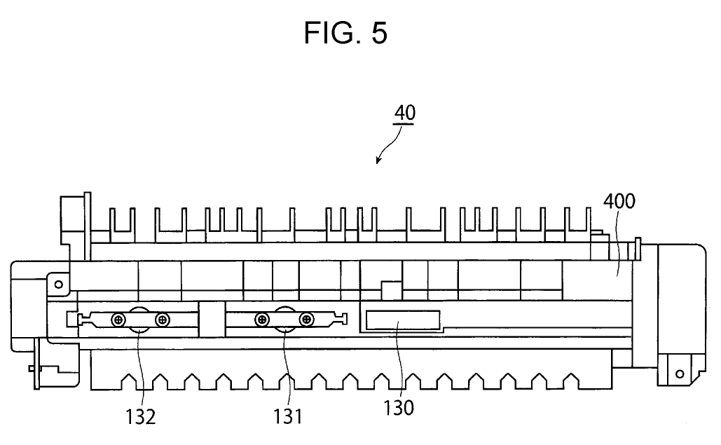

As illustrated in FIG. 5, the first temperature sensor 130 is disposed in a housing 400 of the fixing device 40 at a portion near the center portion of the heating roller 41 in the longitudinal direction to face the surface of the heating roller 41 while leaving a predetermined gap therebetween without being in contact with the heating roller 41. FIG. 5 is a side view of the housing 400 of the fixing device 40 viewed in a direction of arrow in FIG. 4. FIG. 5 illustrates a first thermostat 131 disposed at the center portion of the heating roller 41 in the longitudinal direction and a second thermostat 132 disposed at one end portion of the heating roller 41 in the longitudinal direction. The first thermostat 131 automatically breaks electricity transmitted to the first halogen lamp 414a when the surface temperature of the heating roller 41 at the center portion exceeds a specified upper limit. The second thermostat 132 automatically breaks electricity transmitted to the second halogen lamp 414b when the surface temperature of the heating roller 41 at the end portion exceeds a specified upper limit.

As illustrated in FIG. 2, the electricity supplied to the halogen lamps 414 is controlled to be turned on or off by an electricity control circuit 125 included in the controller 102 and formed from, for example, a triac based on a detection result from the first temperature sensor 130. The surface of the heating roller 41 is thus kept at a predetermined fixing temperature (for example, approximately 140 to 150°C).

As illustrated in FIG. 3 and FIG. 4, the pressing belt 42 is an endless belt having a thin hollow cylindrical shape. The pressing belt 42 includes, for example, a base layer, an elastic layer coated on the surface of the base layer, and a release layer coated on the surface of the elastic layer.

As illustrated in FIG. 3, the pressing member 43 is disposed inside the pressing belt 42. The pressing member 43 includes a pressing pad 46 that presses the pressing belt 42 against the surface of the heating roller 41, and a support member 47 that supports the pressing pad 46 and has higher hardness than the pressing pad 46.

The support member 47 includes an attachment 471 disposed at a portion away from the heating roller 41. The attachment 471 allows the support member 47 to be attached to the holding member 44. The attachment 471 of the support member 47 holds a horizontal plate portion 441a of a holding plate 441 of the holding member 44 having an L-shaped cross section, with a first clamp plate 471a and a second clamp plate 471b. The attachment 471 of the support member 47 is attached to the holding member 44 while being fixed as appropriate with, for example, an adhesive.

The attachment 471 of the support member 47 includes multiple locking protrusions 472 arranged in the longitudinal direction to lock the leading end portion of the sliding sheet 45.

As illustrated in FIG. 3, the holding member 44 holds the pressing pad 46 and the support member 47. The pressing pad 46 and the support member 47 receive a reaction force from the heating roller 41 as a result of being pressed against the surface of the heating roller 41. The holding member 44 has high hardness not to be bent or deformed in the longitudinal direction by the reaction force exerted on the pressing pad 46 and the support member 47 from the heating roller 41. The holding member 44 includes the holding plate 441 and a holding body 442. The holding plate 441 is formed by, for example, a drawing or bending process performed on metal such as aluminum or stainless steel to have a substantially L-shaped cross section. The holding body 442 is formed from, for example, heat-resistant synthetic resin fixed to the holding plate 441 in the longitudinal direction.

The felt member 49 is disposed at a vertical plate portion 441b of the holding plate 441 by, for example, sticking or adhesion using a double-sided tape not illustrated. The felt member 49 is preliminarily impregnated with a lubricant to be applied to, for example, the inner peripheral surface of the pressing belt 42. For example, amino modified silicone oil is used as the lubricant.

The sliding sheet 45 is formed from a thin, long, flat rectangular sheet. As an example of the sliding sheet 45, a construction including a base layer formed from fluororesin such as polytetrafluoroethylene (PTFE) and a textile or knitting formed from, for example, aramid fiber and laminated on a surface or both top and rear surfaces of the base layer is used.

As illustrated in FIG. 3 and FIG. 4, guide members 48 guide both end portions of the pressing belt 42 in the longitudinal direction to allow the pressing belt 42 to circularly move. The guide members 48 are formed from members with a substantially disk shape when viewed from the front and disposed at both end portions of the holding plate 441 in the longitudinal direction. A guide portion that guides the circular movement of the pressing belt 42 is disposed on the inner periphery of each of the guide members 48 to protrude inward in the longitudinal direction.

As illustrated in FIG. 2, when the fixing device 40 with the above structure receives command information of a request for an image forming operation (print) from, for example, the control panel 101, the halogen lamps 414a and 414b serving as heat sources receive electricity and the heating roller 41 starts being heated at the start of the image forming operation. The surface temperature of the heating roller 41 is detected by the first temperature sensor 130. The controller 102 of the control device 100 determines whether the surface temperature of the heating roller 41 has reached a warm-up temperature serving as a target temperature in accordance with the surface temperature of the heating roller 41 detected by the first temperature sensor 130. When the controller 102 detects that the surface temperature of the heating roller 41 has reached the warm-up temperature, the status is changed to a print status and the photoconductor drum 11 of each of the image forming devices 10 (10Y, 10M, 10C, and 10K) is driven to rotate to start the image forming operation.

The fixing device 40 includes, as the first temperature sensor 130, an NC sensor exhibiting not very high responsivity. Thus, when the fixing device 40 determines whether the surface temperature of the heating roller 41 has reached a target temperature, the fixing device 40 inevitably causes detection delay, or detection of the surface temperature of the heating roller 41 as being lower than an actual surface temperature.

Thus, a fixing device 40 to which the first exemplary embodiment has not been applied yet determines that the surface temperature of the heating roller 41 has not reached the target temperature regardless of when the surface temperature of the heating roller 41 has already reached the warm-up temperature serving as the target temperature. The controller 102 determines that the surface temperature of the heating roller 41 has reached the warm-up temperature only after the first temperature sensor 130 actually detects the target temperature as the surface temperature of the heating roller 41. Thus, in the image forming apparatus 1 including the fixing device 40, the detection delay of the first temperature sensor 130 prolongs the warm-up time. Thus, printers have technical issues or fail to clear the international environmental standards that define, for example, emissions of ultrafine particle (UFP), power consumption, or stand-by time at the rising time.

The present exemplary embodiment thus includes a determiner that determines whether the heatable portion has reached a target temperature after correcting the detection delay of the first temperature detector using an actual temperature obtained by preliminarily detecting a temperature change of the heatable portion at the start of heating using a second temperature detector exhibiting higher responsivity than the first temperature detector.

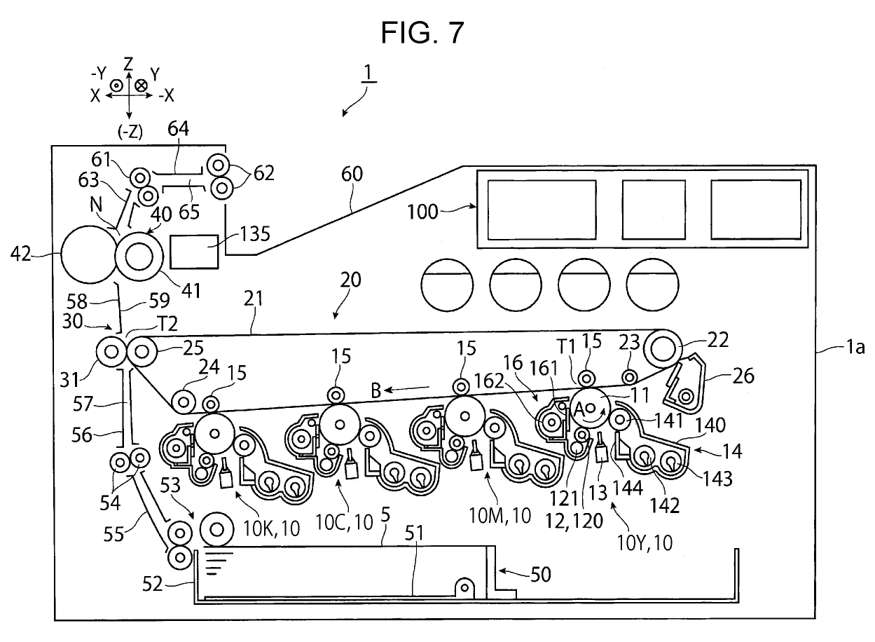

More specifically, as illustrated in FIG. 7, an offline bench including the fixing device 40 to be installed in an actual device is fabricated as the image forming apparatus 1 according to the first exemplary embodiment. The fixing device 40 in the offline bench includes, instead of the first temperature sensor 130 formed from an NC sensor used in an actual device as a temperature detector that detects the surface temperature of the heating roller 41, a radiation thermometer 135 as an example of a second temperature detector exhibiting higher responsivity than a temperature sensor formed from the NC sensor.

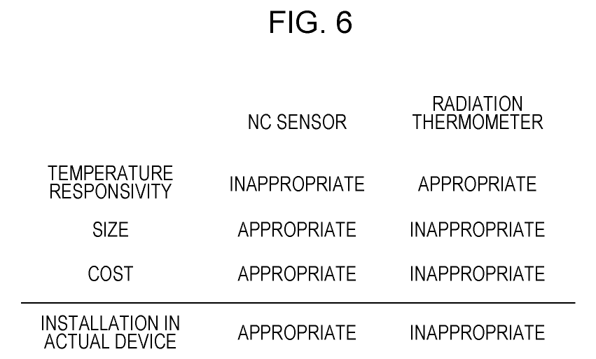

The radiation thermometer 135 detects the temperature by measuring the amount of infrared energy radiated from an object. As illustrated in FIG. 6, the radiation thermometer 135 has higher responsivity than the first temperature sensor 130 formed from an NC sensor, and is thus capable of detecting the temperature of an object in extremely short time. The radiation thermometer 135, however, has a relatively large size and costs high, and is thus not suitable to be installed in the image forming apparatus 1 serving as an actual device.

As illustrated in FIG. 7, in the image forming apparatus 1 according to the first exemplary embodiment, instead of the first temperature sensor 130, the radiation thermometer 135 is attached to the offline bench including the fixing device 40 having the same structure as the actual device at the same position as the first temperature sensor 130. An offline bench does not necessarily need to include the entire image forming apparatus 1, and an offline bench simply including the fixing device 40 may be adopted as long as it is capable of reproducing the state at the starting of heating the heating roller 41 in the fixing device 40.

A bench model of the image forming apparatus 1 including the fixing device 40 to which the radiation thermometer 135 is attached or a bench model of the fixing device 40 to which the radiation thermometer 135 is attached is installed under the environment with a normal temperature and a normal humidity the same as the actually installed environment such as an office.

Thereafter, electricity starts being supplied to the halogen lamps 414a and 414b of the heating roller 41 of the fixing device 40 under the same conditions as the start of the image forming operation, and the heating roller 41 starts heating. Then, a change of the surface temperature of the heating roller 41 at the start of heating is detected (measured) by the radiation thermometer 135.

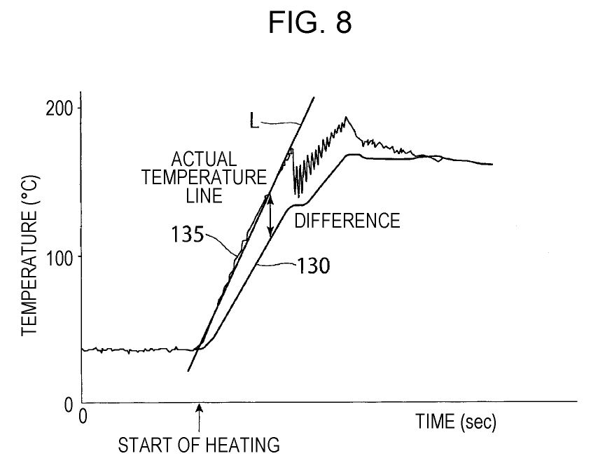

FIG. 8 is a graph of results obtained by the radiation thermometer 135 and the first temperature sensor 130 detecting (measuring) the surface temperature of the heating roller 41 at the start of heating.

Here, the surface temperature of the heating roller 41 detected at the start of heating by the radiation thermometer 135 with higher responsivity than the first temperature sensor 130 is referred to as "an actual temperature". A curve or a straight line indicating the temperature change, at the rising time, of the surface temperature of the heating roller 41 detected at the start of heating by the radiation thermometer 135 is referred to as "an actual temperature line".

As is clear from FIG. 8, the result of the surface temperature of the heating roller 41 preliminarily detected at the start of heating by the radiation thermometer 135 rapidly rises into a substantially straight line concurrently with the start of heating or the start of providing electricity to the halogen lamps 414a and 414b.

In contrast, the result of the surface temperature of the heating roller 41 detected at the start of heating by the first temperature sensor 130 rises later than the result detected by the radiation thermometer 135 after the start of heating or the start of providing electricity to the halogen lamps 414a and 414b. The result detected by the first temperature sensor 130 rises into a straight line with a smaller inclination than the result detected by the radiation thermometer 135.

When the controller 102 detects that the surface temperature of the heating roller 41 has reached the warm-up temperature serving as a predetermined target temperature, the controller 102 changes the status to the print status, and performs a predetermined image forming operation including the start of rotation of the heating roller 41.

Thus, the surface temperature of the heating roller 41 temporarily drops due to, for example, the start of rotation of the heating roller 41, and then rises, although fluctuates (changes) while gradually reducing the amplitude.

Although the surface temperature of the heating roller 41 slightly drops due to the start of the fixing operation, the electricity supplied to the halogen lamps 414a and 414b is controlled by the electricity control circuit 125, and the surface temperature of the heating roller 41 is kept at substantially the same temperature as a predetermined fixing temperature.

The results of the surface temperature of the heating roller 41 detected at the start of heating by the radiation thermometer 135 and the first temperature sensor 130 are to coincide or to be reproducible under the same detection conditions, more specifically, when the same image forming apparatus 1 and the same fixing device 40 are used and under the same environmental conditions (environmental temperature). More specifically, under the same environmental temperature, the amount of heat at the start of supplying electricity to the halogen lamps 414a and 414b of the heating roller 41 is uniform, and the heat capacity of the fixing device 40 including the heating roller 41, and the heat capacity of the image forming apparatus 1 are uniform. Thus, under the same environmental temperature, the change of the surface temperature of the heating roller 41 at the start of supplying electricity to the halogen lamps 414a and 414b of the heating roller 41 is regarded as being reproducible regardless of when the surface temperature is detected by the radiation thermometer 135 or detected by the first temperature sensor 130.

In other words, in offline benches including the same image forming apparatus 1 and the same fixing device 40, as illustrated in FIG. 8, the result of the surface temperature of the heating roller 41 detected at the start of heating by the radiation thermometer 135 is always regarded as having the same relationship with the result of the surface temperature of the heating roller 41 in the actual device detected by the first temperature sensor 130.

The experimental results of the present inventors reveal that, when the environmental temperature is smaller than or equal to a predetermined upper limit, the detection result of the surface temperature of the heating roller 41 at the start of heating varies only in the temperature at the start, and the inclination of the actual temperature remains unchanged. The case where the environmental temperature exceeds a predetermined upper limit is, for example, a case where components such as the heating roller 41 or the pressing belt 42 are being heated with insufficient elapse of time after the finish of the image forming operation performed by the image forming apparatus 1.

In the fixing device 40 according to the first exemplary embodiment, an actual temperature serving as a result preliminarily detected by the radiation thermometer 135 in the bench model including the same fixing device 40 is used as a temperature change of the heating roller 41 at the start of heating.

The actual temperature serving as a temperature change of the heating roller 41 preliminarily detected by the radiation thermometer 135 at the start of heating and the actual temperature line are preliminarily stored in the ROM 122 as data. As illustrated in FIG. 8, as examples of the actual temperature and the actual temperature line, data relating to time and the temperature may be directly stored in a table form. As illustrated in this drawing, the actual temperature line may be approximated with a straight line L, and preliminarily stored in the ROM 122 as data formed from, for example, a mathematical expression indicating the straight line L. In the first exemplary embodiment, data obtained by approximation with the straight line L is used as the actual temperature line.

At the start of heating the heating roller 41, the controller 102 reads the actual temperature line serving as the temperature change of the heating roller 41 at the start of heating as data stored in the ROM 122. The controller 102 corrects the detection result of the surface temperature of the heating roller 41 detected by the first temperature sensor 130 at the start of heating with data of the actual temperature serving as the read temperature change of the heating roller 41 and the actual temperature line, and determines whether the heating roller 41 has reached the warm-up temperature serving as the target temperature.

When the controller 102 determines whether the heating roller 41 has reached the warm-up temperature serving as the target temperature, the controller 102 corrects the warm-up temperature serving as the target temperature of the heating roller 41 with data of the actual temperature line of the heating roller 41.

More specifically, as illustrated in FIG. 8, the controller 102 corrects the target temperature by subtracting the difference between data of the actual temperature and the actual temperature line of the heating roller 41 and the detection result of the first temperature sensor 130 from the warm-up temperature serving as the target temperature of the heating roller 41.

### Operation of Fixing Device

When determining whether the heatable portion has reached the target temperature in the following manner, regardless of when including a first temperature detector with relatively lower responsivity, the fixing device 40 according to the first exemplary embodiment is capable of determining early whether the heatable portion has reached the target temperature compared to the case where the detection delay of the first temperature detector is not corrected with an actual temperature preliminarily detected by a second temperature detector with higher responsivity than the first temperature detector used in the actual device.

More specifically, as illustrated in FIG. 1, when the image forming apparatus 1 including the fixing device 40 according to the first exemplary embodiment receives instruction information of a request for an image forming operation (print), the control device 100 controls components including the four image forming devices 10 (10Y, 10M, 10C, and 10K), the intermediate transfer device 20, the second transfer device 30, and the fixing device 40 to actuate the components.

As illustrated in FIG. 2, in the fixing device 40 according to the first exemplary embodiment, the electricity starts being supplied to the halogen lamps 414a and 414b in the heating roller 41, and the heating roller 41 is heated by the halogen lamps 414a and 414b.

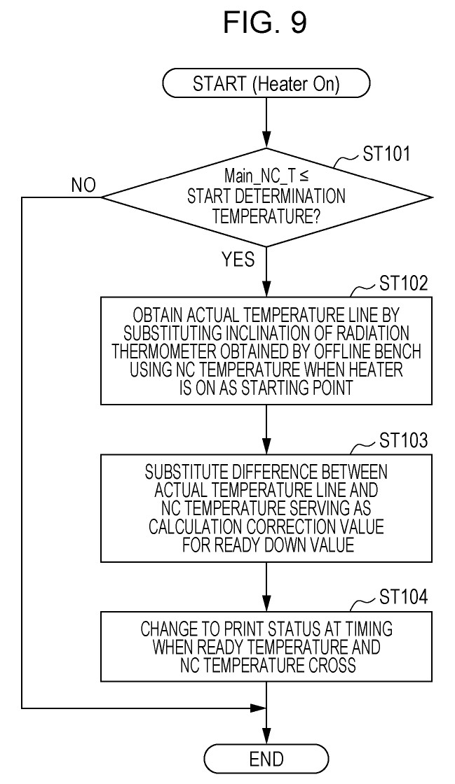

First, as illustrated in FIG. 9, in the fixing device 40, a surface temperature Main_NC_T of the heating roller 41 at the start of heating is detected by the first temperature sensor 130 formed from an NC sensor. The controller 102 then determines whether the detected temperature Main_NC_T is lower than or equal to a start determination temperature (step ST101). The start determination temperature is, for example, set to a temperature higher than the normal room temperature at approximately 40 to 50°C. This start determination temperature is used to determine whether the control operation according to the first exemplary embodiment is applicable. When determining that the detected temperature Main_NC_T exceeds the start determination temperature, the controller 102 finishes the process as soon as possible, and switches to the normal control based on the detection results from the first temperature sensor 130.

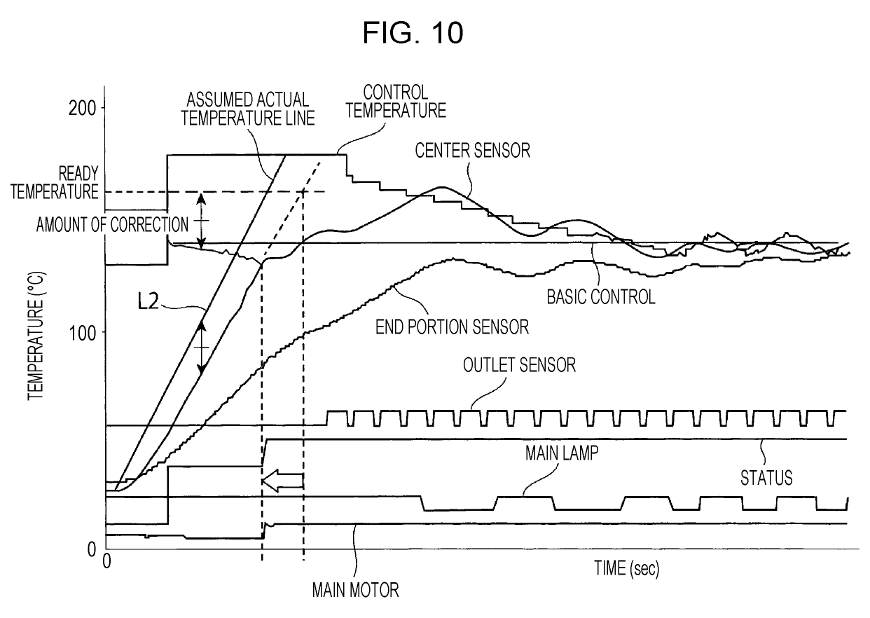

When determining that the detection temperature detected by the first temperature sensor 130 is lower than or equal to the start determination temperature, the controller 102 performs the subsequent control. More specifically, using, as a starting point, the temperature Main_NC_T detected by the first temperature sensor 130 when the halogen lamps 414a and 414b are turned on, the inclination of the actual temperature line of the radiation thermometer 135 obtained by the offline bench is substituted to obtain the actual temperature line L2 as illustrated in FIG. 10 (step ST102). The actual temperature line L2 is obtained by substituting the value of the temperature Main_NC_T detected by the first temperature sensor 130 into a formula of a straight line L indicating the actual temperature line preliminarily stored in the ROM 122. Specifically, the actual temperature line L2 is a formula of a straight line L passing the temperature Main_NC_T detected by the first temperature sensor 130.

The controller 102 then sequentially calculates the difference between the actual temperature line L2 and the detection temperature detected by the first temperature sensor 130. As illustrated in FIG. 9, the controller 102 then substitutes the obtained difference as a correction value into a ready down value (step ST103).

The controller 102 then switches to the print status to start the image forming operation at the timing when the ready temperature and the detection temperature detected by the first temperature sensor 130 match and cross (step ST104), and finishes the rising control operation.

As illustrated in FIG. 1, the image forming apparatus 1 then drives components including each image forming device 10 to start the image forming operation.

In this manner, in the image forming apparatus 1 including the fixing device 40 according to the first exemplary embodiment, the surface temperature of the heating roller 41 at the start of heating the heating roller 41 is detected by the first temperature sensor 130. When determining whether the surface temperature of the heating roller 41 has reached the warm-up temperature serving as a target temperature based on the surface temperature of the heating roller 41 detected by the first temperature sensor 130, the controller 102 corrects the detection delay of the first temperature sensor 130 using data of the actual temperature line L2 obtained by preliminarily detecting the temperature change of the heating roller 41 at the start of heating using the radiation thermometer 135 with higher responsivity than the first temperature sensor 130.

Thus, the image forming apparatus 1 including the fixing device 40 according to the first exemplary embodiment is capable of determining early whether the surface temperature of the heating roller 41 has reached the warm-up temperature serving as a target temperature while exhibiting the same responsivity as high responsivity of the radiation thermometer 135 exerted when the radiation thermometer 135 detects the surface temperature of the heating roller 41 at the start of heating the heating roller 41.

Thus, the image forming apparatus 1 including the fixing device 40 according to the first exemplary embodiment is capable of reducing the warm-up time. The image forming apparatus 1 is thus capable of achieving environmental standard values that internationally define values for a printer, such as, emissions of ultrafine particle (UFP), power consumption, and rising standby time.

In the exemplary embodiment described above as an example, the determiner corrects the detection delay of the first temperature detector by changing the target temperature, but this is not the only possible example. For example, the determiner may correct the detection delay of the first temperature detector by changing the detection result of the first temperature detector.

In this case, the determiner determines whether the heatable portion has reached the target temperature by adding the difference between the detection result detected by the first temperature detector and the actual temperature detected by the second temperature detector to the detection result detected by the first temperature detector.

In the exemplary embodiment, a color image forming apparatus including image forming devices for yellow (Y), magenta (M), cyan (C), and black (K) is described as an image forming apparatus, but the image forming apparatus according to the embodiment is also applicable to a monochrome image forming apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(1) A fixing device comprising: a heatable portion that is heated by a heat source; a first temperature detector that detects a temperature of the heatable portion; and a determiner that determines whether the heatable portion has reached a target temperature after correcting detection delay of the first temperature detector using an actual temperature, the actual temperature being obtained by preliminarily detecting a temperature change of the heatable portion at a start of heating using a second temperature detector exhibiting higher responsivity than the first temperature detector.

(2) The fixing device according to 1, wherein the determiner corrects the detection delay of the first temperature detector by changing the target temperature.

(3) The fixing device according to 2, wherein the determiner determines whether the heatable portion has reached the target temperature by subtracting a difference between an actual temperature detected by the second temperature detector and a detection temperature detected by the first temperature detector from the target temperature.

(4) The fixing device according to 1, wherein the determiner corrects the detection delay of the first temperature detector by changing a detection result of the first temperature detector.

(5) The fixing device according to 4, wherein the determiner determines whether the heatable portion has reached the target temperature by adding a difference between the detection result of the first temperature detector and an actual temperature detected by the second temperature detector to the detection result of the first temperature detector.

(6) The fixing device according to 1, wherein the first temperature detector is formed from a non-contact temperature sensor.

(7) The fixing device according to 1, wherein the second temperature detector is formed from a radiation thermometer.

(8) The fixing device according to 1, wherein the determiner holds the actual temperature preliminarily detected by the second temperature detector as data approximated with a straight line.

(9) The fixing device according to 1, wherein the determiner determines whether the heatable portion has reached the target temperature when a detection result of the first temperature detector is smaller than or equal to a predetermined threshold, and the determiner does not determine whether the heatable portion has reached the target temperature when the detection result of the first temperature detector exceeds the predetermined threshold.

(10) An image forming apparatus, comprising: an image forming unit that forms an image on a recording medium; and a fixing unit that fixes the image on the recording medium, wherein the fixing device according to any one of 1 to 9 is used as the fixing unit.

What is claimed is:

1. A fixing device comprising:
a heatable portion that is heated by a heat source;
a first temperature detector that detects a temperature of the heatable portion; and
a determiner that determines whether the heatable portion has reached a target temperature after correcting detection delay of the first temperature detector using an actual temperature, the actual temperature being obtained by preliminarily detecting a temperature change of the heatable portion at a start of heating using a second temperature detector exhibiting higher responsivity than the first temperature detector.

2. The fixing device according to claim 1,
wherein the determiner corrects the detection delay of the first temperature detector by changing the target temperature.

3. The fixing device according to claim 2,
wherein the determiner determines whether the heatable portion has reached the target temperature by subtracting a difference between an actual temperature detected by the second temperature detector and a detection temperature detected by the first temperature detector from the target temperature.

4. The fixing device according to claim 1,
wherein the determiner corrects the detection delay of the first temperature detector by changing a detection result of the first temperature detector.

5. The fixing device according to claim 4,
wherein the determiner determines whether the heatable portion has reached the target temperature by adding a difference between the detection result of the first temperature detector and an actual temperature detected by the second temperature detector to the detection result of the first temperature detector.

6. The fixing device according to claim 1,
wherein the first temperature detector is formed from a non-contact temperature sensor.

7. The fixing device according to claim 1,
wherein the second temperature detector is formed from a radiation thermometer.

8. The fixing device according to claim 1,
wherein the determiner holds the actual temperature preliminarily detected by the second temperature detector as data approximated with a straight line.

9. The fixing device according to claim 1,
wherein the determiner determines whether the heatable portion has reached the target temperature when a detection result of the first temperature detector is smaller than or equal to a predetermined threshold, and the determiner does not determine whether the heatable portion has reached the target temperature when the detection result of the first temperature detector exceeds the predetermined threshold.

10. An image forming apparatus, comprising:
an image forming unit that forms an image on a recording medium; and
a fixing unit that fixes the image on the recording medium,
wherein the fixing device according to claim 1 is used as the fixing unit.

11. An image forming apparatus, comprising:
an image forming unit that forms an image on a recording medium; and
a fixing unit that fixes the image on the recording medium,
wherein the fixing device according to claim 2 is used as the fixing unit.

12. An image forming apparatus, comprising:
an image forming unit that forms an image on a recording medium; and
a fixing unit that fixes the image on the recording medium,
wherein the fixing device according to claim 3 is used as the fixing unit.

13. An image forming apparatus, comprising:
an image forming unit that forms an image on a recording medium; and
a fixing unit that fixes the image on the recording medium,
wherein the fixing device according to claim 4 is used as the fixing unit.

14. An image forming apparatus, comprising:
an image forming unit that forms an image on a recording medium; and
a fixing unit that fixes the image on the recording medium,
wherein the fixing device according to claim 5 is used as the fixing unit.

15. An image forming apparatus, comprising:
an image forming unit that forms an image on a recording medium; and
a fixing unit that fixes the image on the recording medium,
wherein the fixing device according to claim 6 is used as the fixing unit.

16. An image forming apparatus, comprising:
an image forming unit that forms an image on a recording medium; and
a fixing unit that fixes the image on the recording medium,
wherein the fixing device according to claim 7 is used as the fixing unit.

17. An image forming apparatus, comprising:
an image forming unit that forms an image on a recording medium; and
a fixing unit that fixes the image on the recording medium,
wherein the fixing device according to claim 8 is used as the fixing unit.

18. An image forming apparatus, comprising:
an image forming unit that forms an image on a recording medium; and
a fixing unit that fixes the image on the recording medium,
wherein the fixing device according to claim 9 is used as the fixing unit.

19. A fixing device comprising:
heatable means heated by a heat source;
first temperature detection means for detecting a temperature of the heatable means; and
determination means for determining whether the heatable means has reached a target temperature after correcting detection delay of the first temperature detection means using an actual temperature, the actual temperature being obtained by preliminarily detecting a temperature change of the heatable means at a start of heating using a second temperature detection means exhibiting higher responsivity than the first temperature detection means.
